(19) United States
(12) Patent Application Publication
(10) Pub. No.: US 2026/0016564 A1
(43) Pub. Date: Jan. 15, 2026

(54) RADAR DEVICE, RADAR CONTROL METHOD, AND NON-TRANSITORY COMPUTER-READABLE MEDIUM

(71) Applicant: DENSO CORPORATION, Kariya-city (JP)

(72) Inventors: TATSUYA ENAMI, Kariya-city (JP); OSAMU ISAJI, Kariya-city (JP); YUKOU MURASE, Kariya-city (JP); YASUHIRO IDE, Kariya-city (JP)

(21) Appl. No.: 19/338,964

(22) Filed: Sep. 24, 2025

Related U.S. Application Data
(63) Continuation of application No. PCT/JP2024/010139, filed on Mar. 15, 2024.

(30) Foreign Application Priority Data
Mar. 30, 2023 (JP) 2023-055859

(51) Int. Cl. G01S 7/35

(52) U.S. Cl. CPC G01S 7/354; G01S 7/356

(57) ABSTRACT

A radar device includes: at least one transmission antenna; a transmission signal generation unit configured to generate transmission signals modulated by different codes; a reception antenna configured to receive a mixed reception signal; and a control unit configured to process the mixed reception signal. The control unit acquires the mixed reception signal received by a specific reception antenna, defines decode signals obtained by decoding the acquired mixed reception signal for each code, estimates a reception signal component corresponding to each transmission signal in the mixed reception signal, and removes, from the mixed reception signal, the reception signal component corresponding to a transmission signal other than a target transmission signal.

### CROSS REFERENCE TO RELATED APPLICATIONS

The present application is a continuation application of International Patent Application No. PCT/JP2024/010139 filed on Mar. 15, 2024, which designated the U.S. and claims the benefit of priority from Japanese Patent Application No. 2023-055859 filed on Mar. 30, 2023. The entire disclosures of all of the above applications are incorporated herein by reference.

### TECHNICAL FIELD

The present disclosure relates to a technology for controlling a radar device.

### BACKGROUND

A MIMO radar using a pseudorandom phase modulation method has been known as a comparative example. Such a MIMO radar transmits a transmission signal modulated with a different CDM code from each transmission antenna. The MIMO radar generates a decode signal spectrum by decoding a reception signal according to each CDM code, and estimates a side lobe signal component from each decode signal spectrum. The MIMO radar subtracts each estimated side lobe signal component from the decode signal spectrum corresponding to the target transmission antenna. Thereby, a decode signal spectrum in which the side lobe signal components are reduced is acquired.

### SUMMARY

According to an aspect of the present disclosure, a radar device includes: at least one transmission antenna; a transmission signal generation unit configured to generate transmission signals modulated by different codes; a reception antenna configured to receive a mixed reception signal; and a control unit including at least one of (i) a circuit and (ii) a processor with a memory storing computer program code executable by the processor, the at least one of the circuit and the processor configured to cause the control unit to process the mixed reception signal, acquire the mixed reception signal received by a specific reception antenna, define decode signals obtained by decoding the acquired mixed reception signal for each code, estimate a reception signal component corresponding to each transmission signal in the mixed reception signal, and remove, from the mixed reception signal, the reception signal component corresponding to a transmission signal other than a target transmission signal.

### BRIEF DESCRIPTION OF THE DRAWINGS

FIG. 1 is a block diagram showing an overall configuration of a radar device according to a first embodiment.

FIG. 2 is a block diagram illustrating a functional configuration of a control unit according to the first embodiment.

FIG. 3 is a graph showing an example of a transmission signal according to the first embodiment.

FIG. 4 is a schematic diagram showing an overview of estimation of reception signal components.

FIG. 5 is a flowchart showing a radar control method according to the first embodiment.

FIG. 6 is a flowchart showing the radar control method according to the first embodiment.

FIG. 7 is a graph showing dynamic range with and without side lobe reduction.

FIG. 8 is a flowchart showing the radar control method according to a second embodiment.

FIG. 9 is a flowchart showing a radar control method according to a third embodiment.

FIG. 10 is a flowchart showing the radar control method according to a fourth embodiment.

FIG. 11 is a flowchart showing the radar control method according to a fifth embodiment.

FIG. 12 is a schematic diagram conceptually showing an encoding process in a sixth embodiment.

FIG. 13 is a flowchart showing the radar control method according to a sixth embodiment.

FIG. 14 is a flowchart showing the radar control method according to another embodiment.

FIG. 15 is a flowchart showing the radar control method according to another embodiment.

FIG. 16 is a diagram showing the overall configuration of the radar device according to another embodiment.

### DETAILED DESCRIPTION

In the technology of the comparative example, each side lobe signal component due to other transmission antennas is subtracted from each decoded signal spectrum corresponding to each transmission antenna. Therefore, it is necessary to store in a memory the number of decoded signal spectra equal to the number of codes and the same number of side lobe signal components. Therefore, the amount of memory used in the process of reducing the side lobe signal components may increase.

An example of the present disclosure provides a radar device capable of reducing memory usage. Another example of the present disclosure provides a radar control method capable of reducing memory usage. Further, another example of the present disclosure provides a radar control program capable of reducing memory usage.

According to a first example embodiment of the present disclosure, a radar device includes: at least one transmission antenna; a transmission signal generation unit configured to generate a plurality of types of transmission signals modulated by a plurality of different codes to be transmitted from the at least one transmission antenna; a reception antenna configured to receive a mixed reception signal obtained by mixing each transmission signal reflected by a reflection object; and a control unit configured to process the mixed reception signal. The control unit includes: an acquisition unit configured to acquire the mixed reception signal received by a specific reception antenna that is the reception antenna; a definition unit configured to define a plurality of decode signals obtained by decoding the acquired mixed reception signal for each code; an estimation unit configured to estimate a reception signal component corresponding to each transmission signal in the mixed reception signal before decoding from each decode signal corresponding to the plurality of types of transmission signals; and a removal unit configured to remove, from the mixed reception signal, the reception signal component corresponding to a transmission signal other than a target transmission signal among the plurality of types of transmission signals.

According to a second example embodiment of the present disclosure, a radar control method is executed by a processor for controlling a radar device including: at least one transmission antenna; a transmission signal generation unit configured to generate a plurality of types of transmission signals modulated by a plurality of different codes to be transmitted from the at least one transmission antenna; and a reception antenna configured to receive a mixed reception signal obtained by mixing each transmission signal reflected by a reflection object. The radar control method includes: acquiring the mixed reception signal received by a specific reception antenna that is the reception antenna; defining a plurality of decode signals obtained by decoding the acquired mixed reception signal for each code; estimating a reception signal component corresponding to each transmission signal in the mixed reception signal before decoding from each decode signal corresponding to the plurality of types of transmission signals; and removing, from the mixed reception signal, the reception signal component corresponding to a transmission signal other than a target transmission signal among the plurality of types of transmission signals.

According to a third example embodiment of the present disclosure, a non-transitory computer-readable storage medium stores, for controlling a radar device, a radar control program including instructions. The radar device includes: at least one transmission antenna; a transmission signal generation unit configured to generate a plurality of types of transmission signals modulated by a plurality of different codes to be transmitted from the at least one transmission antenna; and a reception antenna configured to receive a mixed reception signal obtained by mixing each transmission signal reflected by a reflection object. The instructions cause a processor to: acquire the mixed reception signal received by a specific reception antenna that is the reception antenna; define a plurality of decode signals obtained by decoding the acquired mixed reception signal for each code; estimate a reception signal component corresponding to each transmission signal in the mixed reception signal before decoding from each decode signal corresponding to the plurality of types of transmission signals; and remove, from the mixed reception signal, the reception signal component corresponding to a transmission signal other than a target transmission signal among the plurality of types of transmission signals.

According to these first to third aspects, the reception signal component estimated from the decode signal is removed from the mixed reception signal before it is decoded. Therefore, it is sufficient to store the mixed reception signal until removal of the reception signal component is completed, and there is less need to store the frequency spectra of the decode signals in the same number as the codes. Therefore, it is possible to reduce memory usage.

The following will describe embodiments of the present disclosure with reference to the drawings. It should be noted that the same reference numerals are assigned to corresponding components in the respective embodiments, and overlapping descriptions may be omitted. When only a part of the configuration is described in the respective embodiments, the configuration of the other embodiments described before may be applied to other parts of the configuration. Further, not only the combinations of the configurations explicitly shown in the description of the respective embodiments, but also the configurations of the plurality of embodiments can be partially combined together even if the configurations are not explicitly shown if there is no problem in the combination in particular.

### FIRST EMBODIMENT

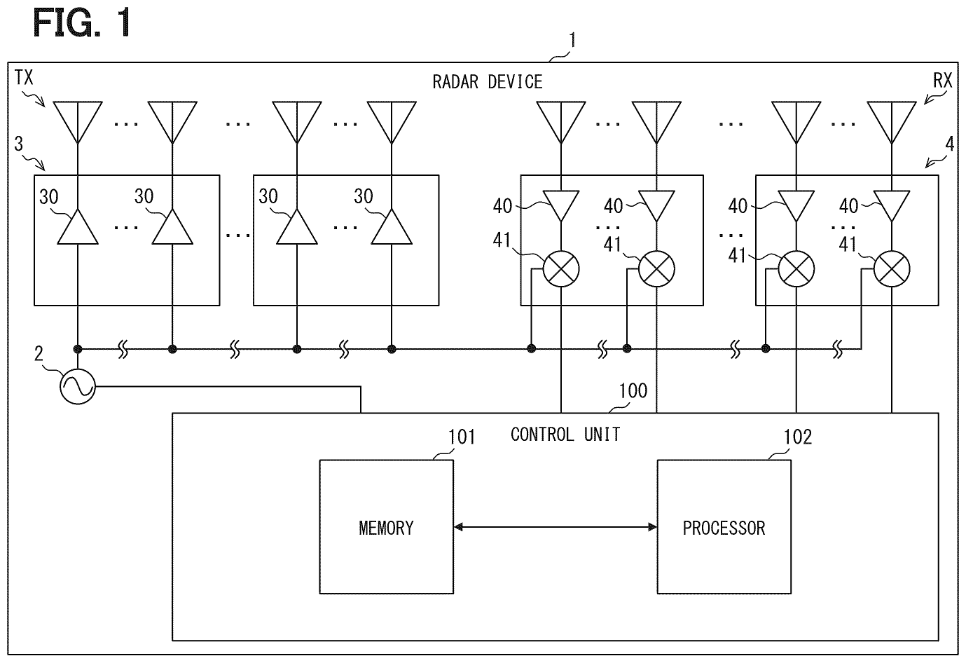

A first embodiment of the present disclosure will be described with reference to FIGS. 1 to 7. A radar device 1 is mounted on a mobile object such as, for example, a vehicle. The radar device 1 transmits a transmission signal St to the external environment, receives the transmission signal St reflected by an object as a reception signal Sr, and detects, as target information, a distance to a target object, which is the object that reflected the transmission signal St, a relative speed to the target object, a direction to the target, and the like.

The target object information output from the radar device 1 is input to an in-vehicle ECU (electronic control unit) via an in-vehicle network such as, for example, a Control Area Network (CAN) (registered trademark) or Ethernet (registered trademark). The in-vehicle ECU executes various processes for automated driving of the vehicle and advanced driving assistance based on the acquired target object information of each target.

The processes based on the target object information include, for example, a collision avoidance process and a warning process. The collision avoidance process is a process of controlling the vehicle to avoid collision with the target object by controlling a brake system, a steering system, and the like based on the target object information of each target object. The warning process is a process for warning the driver of the possibility of a collision with the target object based on the target object information of each target object.

As shown in FIG. 1, the radar device 1 of the present embodiment includes a transmission signal generation unit 2, transmission circuits 3, transmission antennas TX, reception antennas RX, reception circuits 4, and a control unit 100. The radar device 1 is a so-called MIMO (Multiple-Input-Multiple-Output) radar that transmits transmission signals from multiple transmission antennas TX to artificially increase the number of reception antennas RX beyond the actual number.

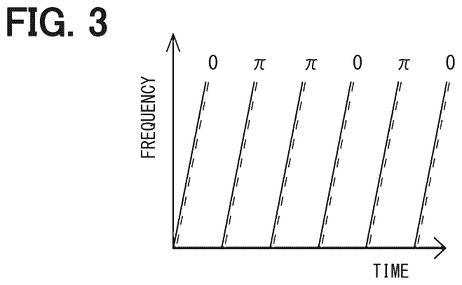

The transmission signal generation unit 2 receives a control signal from the control unit 100, and generates a signal modulated corresponding to the control signal. This generated signal is, for example, a so-called chirp signal whose frequency changes over time (see FIG. 3). The generated signal is distributed and output on each channel of the transmission circuits 3 and the reception circuits 4. The signal generation unit outputs, as a transmission signal, a generated signal to which pseudo-random phase modulation with a different code has been applied for each transmission channel corresponding to each transmission antenna TX. This type of modulation is also called Code Division Multiplexing (CDM). As shown in FIG. 3, in the present embodiment, the transmission signals transmitted from different transmission antennas TX have substantially the same chirp transmission time, center frequency, and frequency band. In FIG. 3, the transmission signals transmitted from different transmission antennas TX are represented by different line types, that is, solid lines and dashed lines.

That is, in the present embodiment, transmission signals to which phase modulation with mutually different codes has been applied are transmitted to the external environment from each of the multiple transmission antennas TX. In addition, the signal output to the reception circuit 4 from the generated signal corresponding to the transmission signal will be referred to as a local signal below.

The transmission circuits 3 and the reception circuits 4 each mainly include a semiconductor integrated circuit device such as a MMIC (Monolithic Microwave Integrated Circuit). The transmission circuits 3 are connected to the transmission antennas TX and output the transmission signal to the transmission antennas TX. A transmission circuit 3 of the transmission circuits 3 includes amplifiers 30 in the same number as the number of connected transmission antennas TX. The amplifiers 30 amplify the transmission signal output from the transmission signal generation unit 2 and output the amplified signals to the corresponding transmission antennas TX.

The transmission antenna TX converts an electrical signal, which is a transmission signal supplied from the transmission signal generation unit 2, into a radio wave signal and transmits it to the external environment. In the present embodiment, it is assumed that twelve transmission antennas TX are provided. In the following description, when each transmission antenna TX is to be individually distinguished, it will be referred to as transmission antenna TXn (n is a natural number from 1 to 12). The transmission antenna TX includes at least one antenna element. For example, the transmission antenna TX is a patch antenna having flat-plate-shaped antenna elements. The antenna element is provided on a dielectric substrate. The dielectric substrate has a surface on which a ground plane is provided and a surface on which the antenna element is provided. The antenna element is provided on the dielectric substrate in a position facing the ground plane. The multiple antenna elements are connected, for example, in series, by a feed line that supplies an electric signal.

The reception antenna RX receives, as a reception signal, a radio wave signal including a transmitted signal reflected from a target in the external environment as a reflecting object. Each of the multiple reception antennas RX receives a signal in which reception signals corresponding to the respective transmission signals from the multiple transmission antennas TX are mixed together. Hereinafter, the mixed signal received by each reception antenna RX will be referred to as a mixed reception signal. Then, the components of the reception signals, which are mixed into the mixed reception signal and correspond to the transmission signals from the multiple transmission antennas TX, are referred to as reception signal components.

The reception antenna RX converts the reception signal, which is a radio wave signal, into an electric signal and outputs it to the corresponding reception circuit 4. The reception antenna RX is, for example, a patch antenna having at least one antenna element connected in series by a feeder line, similar to the transmission antenna TX.

The reception circuit 4 is connected to a reception antenna RX and acquires a reception signal received by the reception antenna RX. The reception circuit 4 includes an amplifier 40 and a signal mixing unit 41, the number of which is equal to the number of reception antennas RX connected.

The amplifier 40 amplifies the reception signal received by the reception antenna and outputs the amplified signal to the signal mixing unit 41. The signal mixing unit 41 generates a beat signal by mixing the local signal from the transmission signal generation unit 2 with the reception signal. The generated beat signal is an interference signal that represents a frequency difference between the reception signal and the local signal. The beat signal is output to the control unit 100 after high-frequency components outside the frequency difference between the reception signal and the local signal are filtered out by a low-pass filter (not shown).

The control unit 100 is connected to the signal generation unit and the reception circuit via at least one type of connection, such as, for example, a LAN (Local Area Network) line, wire harness, internal bus, or wireless communication line. The control unit 100 includes at least one dedicated computer.

The dedicated computer constituting the control unit 100 may be a radar electronic control unit (ECU) specialized for controlling the specific radar device 1. The dedicated computer constituting the control unit 100 may be a radar control ECU that controls multiple radar devices 1 mounted on a mobile object. The dedicated computer constituting the control unit 100 may be a sensor control ECU that controls multiple sensors including the radar device 1 and other sensors such as LiDAR (Light Detection and Ranging/Laser Imaging Detection and Ranging).

The dedicated computer constituting the control unit 100 has at least one memory 101 and at least one processor 102. The memory 101 is at least one type of non-transitory tangible storage medium, such as, for example, a semiconductor memory, a magnetic medium, and an optical medium, for storing, in non-transitory manner, computer readable programs and data. Here, the memory 101 may accumulate and retain data even when a host vehicle A is turned off, or may temporary store data by deleting the data when the host vehicle A is turned off. The processor 102 includes at least one type of, for example, a CPU (i.e., Central Processing Unit), a GPU (i.e., Graphics Processing Unit), a RISC (i.e., Reduced Instruction Set Computer)-CPU, a DFP (i.e., Data Flow Processor), a GSP (i.e., Graph Streaming Processor), or the like as a core.

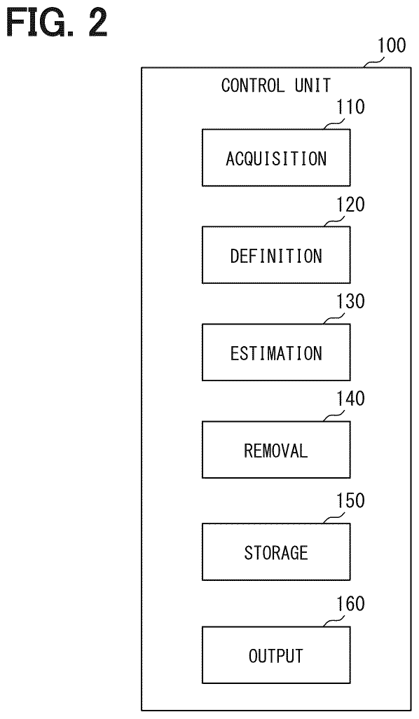

In the control unit 100, the processor 102 executes multiple instructions contained in a radar control program stored in the memory 101 to control the radar device 1. As a result, the control unit 100 constructs multiple functional blocks for controlling the radar device 1. The multiple functional blocks constructed in the control unit 100 include an acquisition block 110, a definition block 120, an estimation block 130, a removal block 140, a storage block 150, and an output block 160, as shown in FIG. 2. The above-described functional blocks can also be referred to as functional units, such as an acquisition unit, a definition unit, an estimation unit, a removal unit, a storage, and an output unit, respectively.

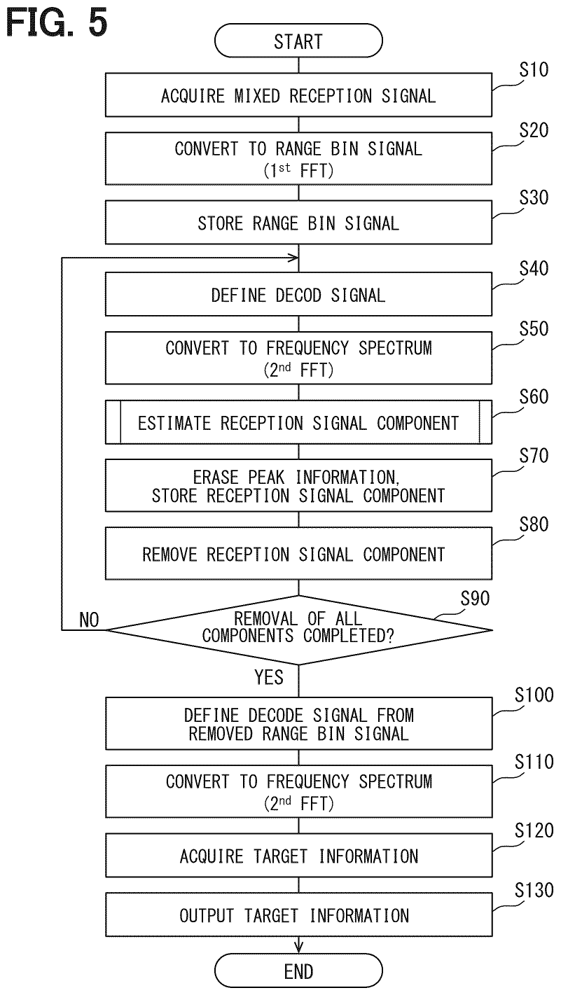

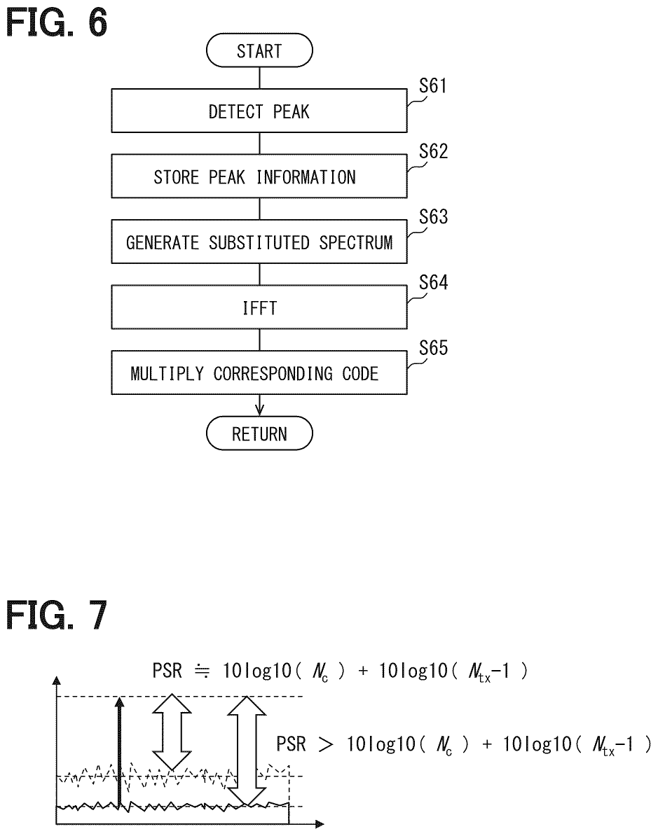

The radar control method in which the control unit 100 controls the radar device 1 through cooperation of these blocks 110, 120, 130, 140, 150, and 160 is executed in accordance with radar control flows shown in FIGS. 5 and 6. The radar control flows are repeatedly executed while the radar device 1 is operating. Here, in the radar control flows, “S” means the processes executed by instructions included in the radar control program.

First, in S10, the acquisition block 110 acquires the mixed reception signal. The mixed reception signal is a beat signal obtained by mixing the local signal from the signal generation unit and the reception signal from the reception antenna RX. The beat signal is an interference signal that represents a frequency difference between the reception signal and the local signal. The mixed reception signal is sampled at predetermined time intervals by an A/D converter and is obtained as a digitized digital signal.

In the following S20, the definition block 120 executes a Fast Fourier Transform (FFT) process on the mixed reception signal. Thus, the definition block 120 acquires the distance spectrum of the mixed reception signal. The acquired distance spectrum is a frequency spectrum that shows peaks according to the distance to the reflection object. Since it is discrete signal data including signal strength information for each bin (range bin) corresponding to distance, it can also be expressed as a range bin signal R. Here, the reception signal component derived from the transmission signal from the transmission antenna TXn and coded with the code Ctₓₙ is denoted as Pₙ. The range bin signal R before decoding can be defined as the sum of the reception signal components CₜₓₙPₙ before decoding from each transmission antenna TX by the following first equation.

$$R = {\sum }_{k} {C}_{t x k} {P}_{k} \qquad ( First Equation )$$

In S30, the storage block 150 stores the range bin signal R in the memory 101. In the following, a process is executed to remove from this range bin signal R reception signal components originating from transmission signals transmitted from transmission antennas other than the target transmission antenna.

In S40, the definition block 120 defines a decode signal responsive to the range bin signal R. Specifically, the definition block 120 generates a decode signal by decoding the range bin signal R with each code corresponding to each transmission antenna TX. In the process of S40, the definition block 120 generates a decode signal for any one code for each loop in the loop process of S40 to S90.

For example, it is assumed that the transmission antenna TX1 is the target transmission antenna. In this case, in S30, the definition block 120 executes decoding for, among the codes Cₜₓ₂ to Cₜₓ₁₂ corresponding to any of the other transmission antennas TX2 to TX12, a code that has not been decoded up to the previous loop. For example, when decoding a specific code Cₜₓₙ, the decode signal is expressed by the following second equation using a coefficient Cₜₓₙ* for decoding the phase modulation by Cₜₓₙ. Here, the coefficient Cₜₓₙ* is a coefficient that becomes 1 when multiplied by Cₜₓₙ.

$$R {C}_{t x n}^{*} = {\sum }_{k} {C}_{t x n}^{*} {C}_{t x k} {P}_{k} \qquad ( Second Equation )$$

In the following S50, the definition block 120 executes the FFT process on the decode signal. Thus, the definition block 120 acquires the frequency spectrum of the mixed reception signal. This frequency spectrum is a velocity spectrum that shows peaks based on the velocity of the reflection object, and is discrete signal data that includes signal intensity information for each bin (velocity bin) based on the velocity. It should be noted that the definition block 120 multiplies the range bin signal R by a window function in the FFT process. In this process, the definition block 120 uses a function other than a rectangular function (rectangular window) as a window function. The window function other than the rectangular function includes, for example, a Hanning function, a Gaussian function, and the like. That is, in the present embodiment, the window function is applied after decoding in the second FFT process.

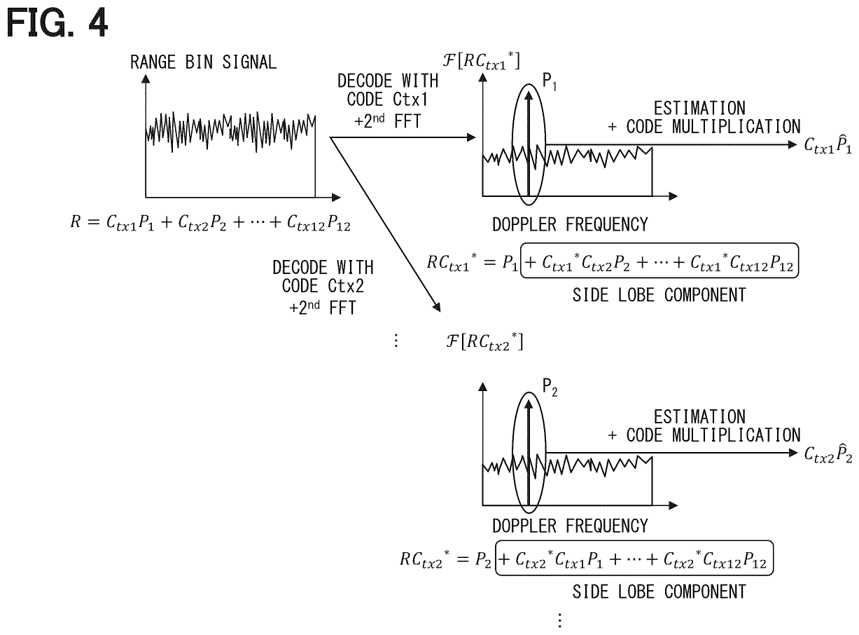

In the above second equation, in a case of k=n, the coefficient of Pn is 1, so as shown in FIG. 4, the velocity spectrum is a combination of peak Pn and a spectrum spread due to other terms.

Then, in S60, the reception signal component CₜₓₙPₙ, corresponding to the transmission signal from the transmission antenna TX corresponding to the code decoded in S30, is estimated.

More specifically, in S61 of FIG. 6, the estimation block 130 detects peaks in the frequency spectrum obtained in S50. In the case of the decode signal RCₜₓₙ*, peak detection corresponds to detecting Pn in the second equation. Next, in S62, peak information relating to the detected peak is stored in the memory 101. The peak information includes, for example, at least information on the phase and amplitude of the peak. Next, in S63, the estimation block 130 generates a spectrum (a substituted spectrum) from the frequency spectrum by replacing signal intensities other than peaks with zero.

In the following S64, the estimation block 130 performs an inverse Fourier transform on the substituted spectrum. As a result, an estimation signal Pₙ\hat{ } is acquired as a distance spectrum. The estimation signal Pₙ \hat{ } is a signal estimated for the pre-encoding reception signal component Pₙ corresponding to the transmission signal from the transmission antenna TXn. Then, in S65, the estimation block 130 multiplies the estimation signal Pn by the corresponding code Cₜₓₙ. Thereby, the estimation block 130 acquires the coded estimation signal CₜₓₙPₙ\hat{ }, which corresponds to CₜₓₙPₙ in the range bin signal R, as the reception signal component corresponding to the transmission signal from the transmission antenna TXn.

Returning to FIG. 5, in S70, the storage block 150 erases the peak information from the memory 101 and stores the estimated reception signal components. Then, in S80, the removal block 140 cancels the coded estimation signal CₜₓₙPₙ\hat{ }, which is estimated as the reception signal component corresponding to the transmitted signal from the transmission antenna TXn, from the range bin signal R.

In S90, the removal block 140 determines whether all reception signal components corresponding to transmission signals from transmission antennas TX other than the target transmission antenna have been removed from the range bin signal R. When the removal has not been completed, the flow returns to S40 and the next loop process is executed to estimate the reception signal components that have not yet been estimated.

On the other hand, when it is determined that all reception signal components corresponding to the transmission signals from the transmission antennas TX other than the target transmission antenna have been removed, the flow proceeds to S100. Here, the removal of all reception signal components corresponding to transmitted signals from transmission antennas TX other than the target transmission antenna TXm corresponds to the separation of the range bin signal Rm for the target transmission antenna TXm from the range bin signal R. The range bin signal Rm can be expressed by the following third equation.

$${R}_{n} = {C}_{t x n} {P}_{n} + {\sum }_{k , k \neq n} ( {C}_{txk} {P}_{k} - {C}_{t x k} {\hat{P}}_{k} ) \approx {C}_{t x n} {P}_{n} \qquad ( Third Equation )$$

In S100, a definition block 120 defines a decode signal from the removed range bin signal Rm. In the following S110, the definition block 120 acquires a frequency spectrum from the decode signal. Then, in S120, the output block 160 acquires target information from the frequency spectrum. The target information includes at least one of the range, speed, or direction of the target. In the next S130, the output block 160 outputs the target information to the outside.

The difference in dynamic range PSR between when the above-described side lobe reduction is performed and when it is not performed will be described with reference to FIG. 7. Assuming one target, the dynamic range PSR can be expressed as the ratio from the maximum value of the peak of the target to the side lobe. When side lobe reduction process is not executed, this dynamic range PSR satisfies the relationship shown in the following fourth equation, where Nc is the total number of chirps in the transmission signal and Ntx is the number of transmission antennas modulated with CDM codes.

$$PSR \approx 10 log 10 ( N c ) + 10 log 10 ( N t x - 1 ) \qquad ( Fourth Equation )$$

On the other hand, when the side lobe reduction process according to the present embodiment is executed, the dynamic range PSR satisfies the relationship shown in the following fifth expression.

$$PSR > 10 log 10 ( N c ) + 10 log 10 ( N t x - 1 ) \qquad ( Fifth Expression )$$

That is, the radar device 1 which performs side lobe reduction has a larger dynamic range PSR than the radar device 1 which does not perform side lobe reduction.

According to the first embodiment described above, the reception signal component estimated from the decode signal is removed from the mixed reception signal before decoding. Therefore, it is sufficient to store the mixed reception signal until removal of the reception signal component is completed, and there is less need to store the frequency spectra of the decode signals in the same number as the codes. Therefore, it is possible to reduce the memory usage.

### SECOND EMBODIMENT

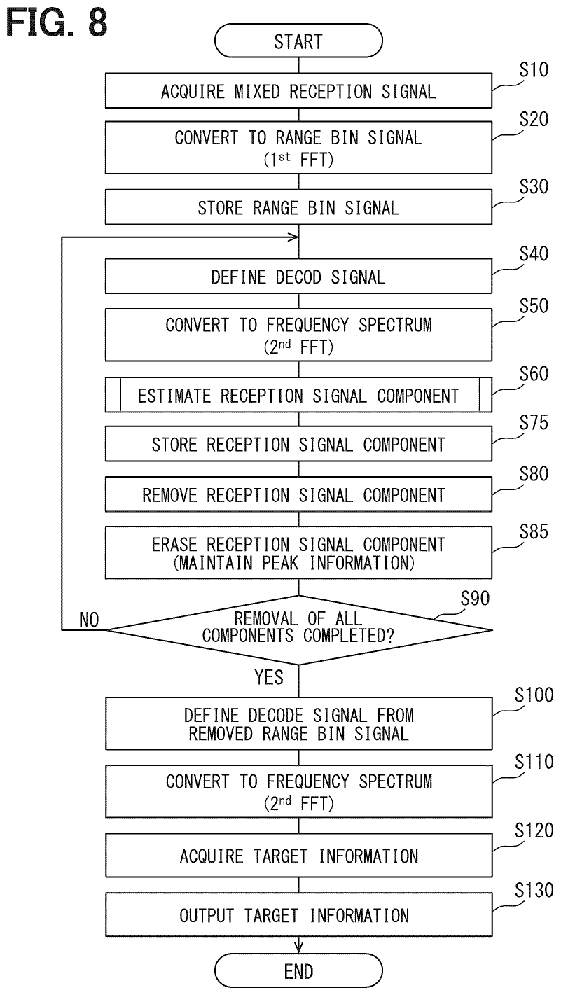

A second embodiment shown in FIG. 8 is a modification of the first embodiment.

In the second embodiment, once the reception signal component is estimated in S60, the flow proceeds to S75. In S75, the storage block 150 stores the reception signal components in the memory 101. Here, the storage block 150 does not erase the peak information stored in S62, but maintains the state in which it is held in the memory 101. After S75, the flow proceeds to S80.

After the process of removing the reception signal component in S80, the flow proceeds to S85. In S85, the storage block 150 erases the removed reception signal component from the memory 101. Incidentally, even in S85, the storage block 150 maintains the peak information. After S85, the flow proceeds to S90.

### THIRD EMBODIMENT

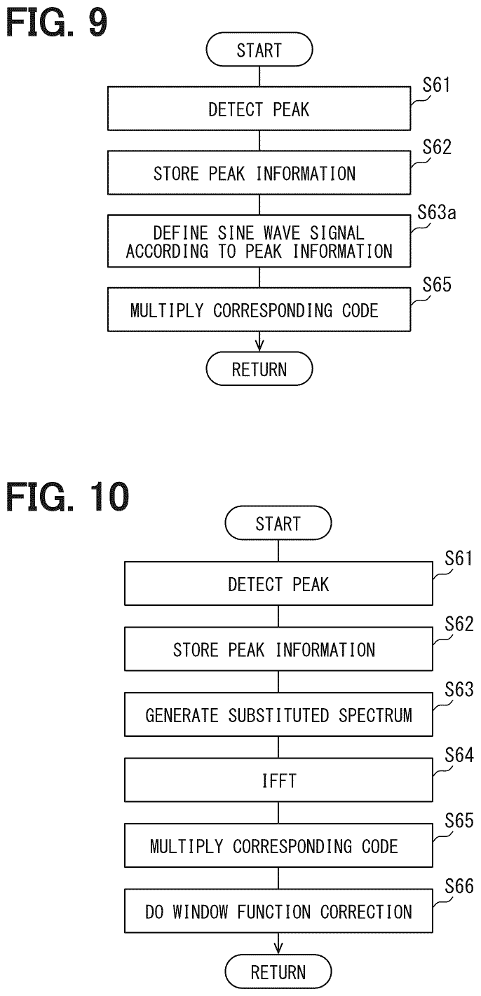

As shown in FIG. 9, a third embodiment is a modification of the first embodiment.

In the third embodiment, as shown in FIG. 9, once the peak information is stored in S62, the flow proceeds to S63a. In S63a, the estimation block 130 defines a sinusoidal signal according to the peak information.

Specifically, the estimation block 130 defines the sinusoidal signal corresponding to the peak according to the phase and amplitude of the peak. For example, the estimation block 130 defines the sinusoidal signal as a result of multiplication of the phase and amplitude of a base signal, which is an underlying sinusoidal signal pre-stored in the memory 101 or the like. Alternatively, the estimation block 130 may define the sinusoidal signal as the result of multiplying the amplitude of the peak by a base signal, which is an underlying sinusoidal signal pre-stored in the memory 101 or the like, and adjusting the phase of the base signal according to the phase of the peak. After S63a, the flow proceeds to S65, where the estimation block 130 defines the reception signal components as the result of multiplying the sinusoidal signal by the code.

### FOURTH EMBODIMENT

A fourth embodiment shown in FIG. 10 is a modification of the first embodiment.

In the fourth embodiment, after S65, the flow shown in FIG. 10 proceeds to S66. In S66, the estimation block 130 performs a correction for the effect of the window function on the coded estimation signal Cₜₓ₂P₂\hat{ }. Specifically, the estimation block 130 multiplies by the inverse of the window function. The estimation block 130 defines the signal components after this correction as the reception signal components.

### FIFTH EMBODIMENT

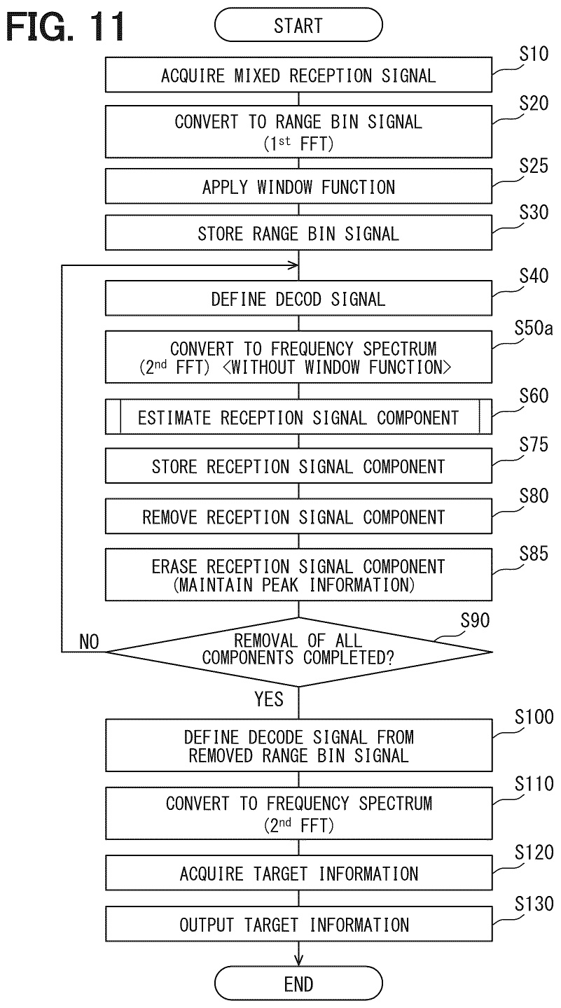

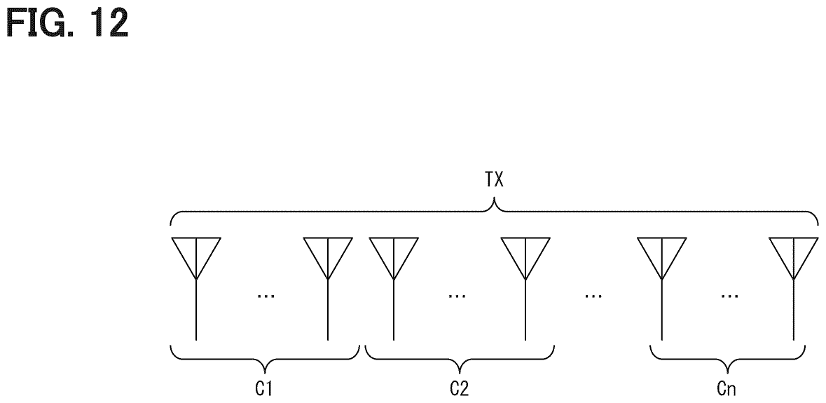

A fifth embodiment shown in FIG. 11 is a modification of the first embodiment.

In the fifth embodiment, after the process of S20, the flow of FIG. 11 proceeds to S25. At S25, the definition block 120 applies a window function to the range bin signal R. Thereafter, the flow proceeds to S30. After S40, the flow shown in FIG. 11 proceeds to S50a. In S50a, the definition block 120 transforms the decode signal into the frequency spectrum without applying any window function other than the rectangular window. In other words, the definition block 120 performs the application of a rectangular window. Note that executing the process of applying the rectangular window is equivalent to stopping the process of applying the window function itself.

According to the fifth embodiment described above, the window function is applied to the signal before the loop process of S40 to S90. That is, in the second FFT process, the window function is applied before decoding. Therefore, it is possible to reduce the need to apply a window function each time a conversion to the velocity spectrum is performed.

### SIXTH EMBODIMENT

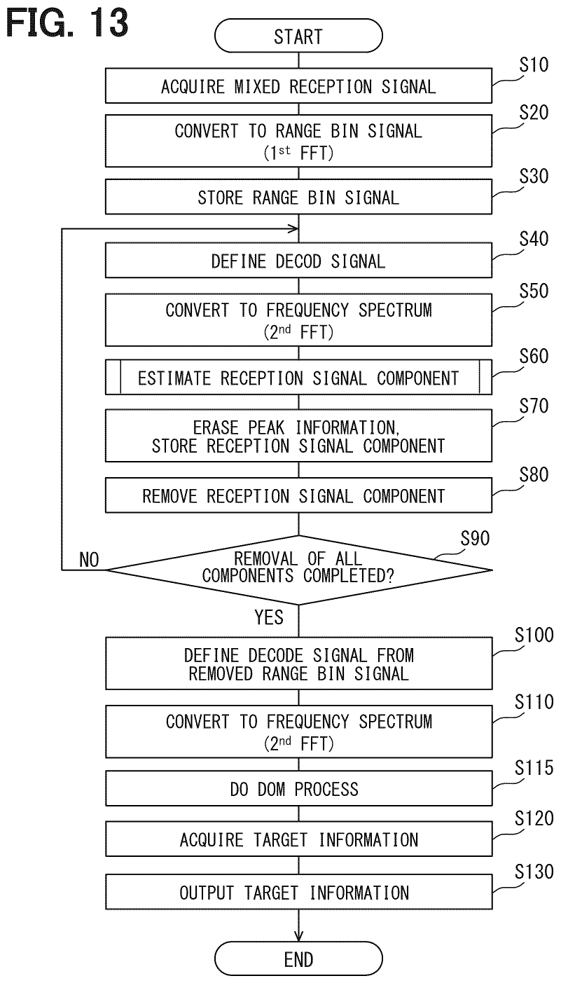

A sixth embodiment shown in FIGS. 12 and 13 is a modification of the sixth embodiment.

As shown in FIG. 12, the transmission signal generation unit 2 applies modulation with a different code to each antenna set including multiple transmission antennas TX. In the example shown in FIG. 12, for each of the n antenna sets, each of which includes a predetermined number of transmission antennas TX, codes C1, C2, . . . , Cn are respectively assigned to each transmission signal from each transmission antenna TX constituting the antenna set. Furthermore, the transmission signal generation unit 2 assigns phase shift keying to each transmission signal corresponding to each transmission antenna TX in the antenna set. It should be noted that phase shift keying is also called velocity modulation or simply phase modulation. The phase shift keying is a modulation method that gives the detected peaks a defined virtual rate.

In this case, the control unit 100 executes the side lobe reduction process for each code of each antenna set in the process of S10 to S110 in FIG. 13. That is, the control unit 100 estimates the reception signal component in a state where reception signals corresponding to each transmission signal with a common code in the antenna set are mixed. That is, the reception signal components estimated in the present embodiment are mixture components of the reception signals corresponding to the transmission signals from the transmission antennas TX in the antenna set.

After the process of S110, the output block 160 separates each reception signal component corresponding to each transmitted signal at the antenna set in S115. Since phase shift keying is applied, different peaks are detected in the velocity spectrum for each reception signal component. Therefore, the output block 160 separates each peak by its corresponding velocity. Thereby, it is possible to acquire the frequency spectrum for each reception signal component corresponding to the transmission signal transmitted from each transmission antenna in the antenna set.

### OTHER EMBODIMENTS

Although multiple embodiments have been described above, the present disclosure is not to be construed as being limited to these embodiments, and can be applied to various embodiments and combinations within a scope not deviating from the gist of the present disclosure.

In a modification, the transmission signal generation unit 2 of the sixth embodiment may impart amplitude modulation to each transmission signal instead of phase shift modulation. In this case, in S115, the output block 160 separates the reception signal components corresponding to the transmitted signals from the antenna set based on differences in peaks caused by the amplitude modulation. It should be noted that amplitude modulation includes so-called time division multiplexing (TDM), which modulates the chirps of each transmission signal so that a time difference occurs between them.

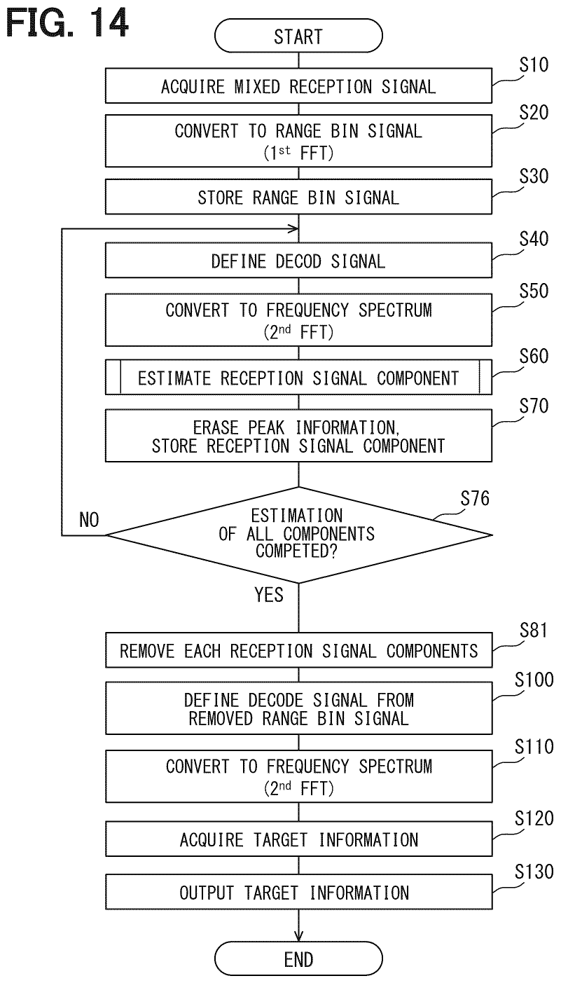

In the modification, the control unit 100 may remove each reception signal component from the range bin signal R after completing the estimation process for all reception signal components other than the reception signal component corresponding to the transmission signal from the target transmission antenna TX. Specifically, as shown in FIG. 14, after S70, it is determined in S76 whether the estimation block has completed estimation of all components. When the estimation is not completed, the flow returns to S40, and when the estimation is completed, the flow proceeds to S81. In S81, the cancellation block cancels each reception signal component estimated from the range bin signal R. After S81, this flow proceeds to S100.

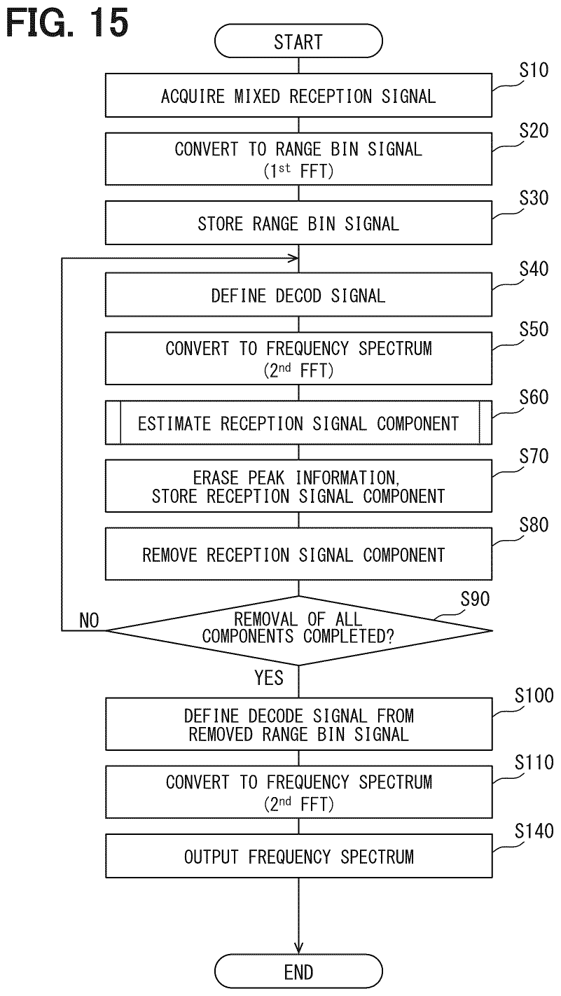

In the modification, the control unit 100 may output the frequency spectrum to the outside instead of the target information. Specifically, as shown in FIG. 15, after S110, the flow proceeds to S140. In S140, the output block outputs the frequency spectrum converted in S110 to the outside. For example, the output block outputs the frequency spectrum to an in-vehicle ECU outside the radar device 1. In this case, the target information and the like are acquired by the in-vehicle ECU of the output destination.

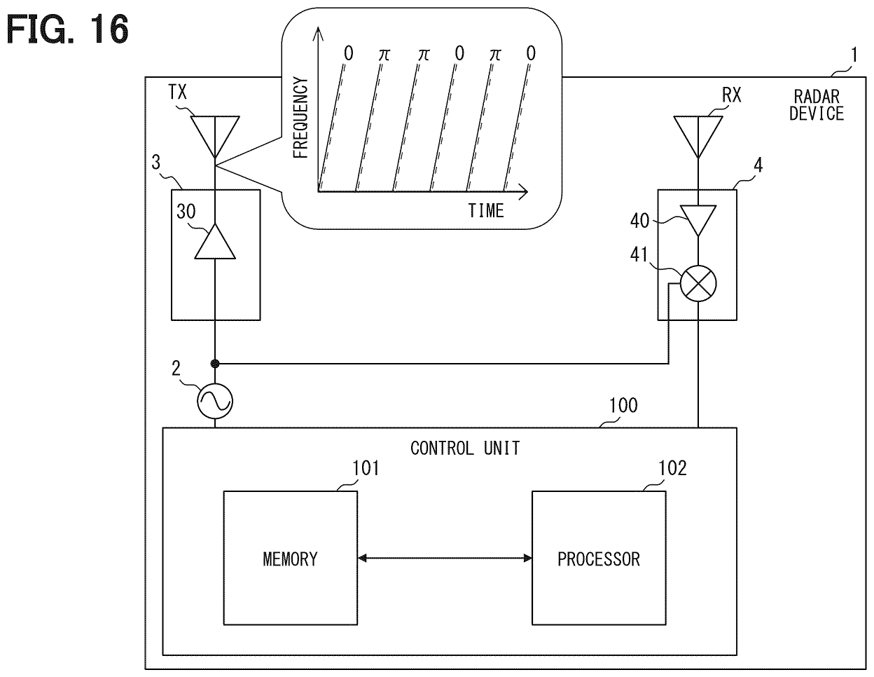

In the modification, the radar device 1 may include only the single transmission antenna TX, as shown in FIG. 16. In this case, the transmission signal generation unit 2 generates a transmission signal for one transmission antenna, which is a mixture of multiple transmission signals modulated with different codes.

In a modification, the dedicated computer constituting the control unit 100 may be an integrated ECU that integrates a driving control of a host vehicle A. The dedicated computer configuring the control unit 100 may be a determination ECU that determines driving tasks in the driving control of the host vehicle A. The dedicated computer constituting the control unit 100 may be a monitoring ECU that monitors the driving control of the host vehicle A. The dedicated computer constituting the control unit 100 may be an evaluation ECU that evaluates the driving control of the host vehicle A.

In the modification, the dedicated computer constituting the control unit 100 may be a navigation ECU that navigates the route of the host vehicle A. The dedicated computer constituting the control unit 100 may be a locator ECU that estimates a self-state quantity of the host vehicle A. The dedicated computer that constitutes the control unit 100 may be an actuator ECU that individually controls the travel actuators of the host vehicle A. The dedicated computer constituting the control unit 100 may be a human machine interface (HMI) control unit (HCU) that controls information presentation in the host vehicle A. The dedicated computer constituting the control unit 100 may be a computer outside of the host vehicle A, for example, constituting an external center or mobile terminal that can communicate with the host vehicle A.

In the modification, a dedicated computer constituting the control unit 100 may include at least one of a digital circuit or an analog circuit, as a processor. The digital circuit is at least one type of, for example, an application specific integrated circuit (i.e., ASIC), an environment programmable gate array (i.e., FPGA), a system on a chip (i.e., SOC), a programmable gate array (i.e., PGA), a complex programmable logic device (i.e., CPLD), or the like. Such a digital circuit may also include a memory in which a program is stored.

In a modification, the host mobile object to which the control unit 100 is applied may be, for example, an autonomous robot capable of transporting luggage or collecting information by autonomous traveling or remote driving. Furthermore, the autonomous robot may be an autonomous traveling robot including an autonomous vehicle.

The embodiments and modifications described above may be implemented as a control device that is configured to be mountable on the mobile object and has at least one processor 102 and at least one memory 101. Specifically, the above-described embodiments and modifications may be implemented in the form of a processing circuit (for example, a processing ECU) or a semiconductor device (for example, a semiconductor chip).

What is claimed is:

1. A radar device comprising:
at least one transmission antenna;
a transmission signal generation unit configured to generate a plurality of types of transmission signals modulated by a plurality of different codes to be transmitted from the at least one transmission antenna;
a reception antenna configured to receive a mixed reception signal obtained by mixing each transmission signal reflected by a reflection object; and
a control unit including at least one of (i) a circuit and (ii) a processor with a memory storing computer program code executable by the processor, the at least one of the circuit and the processor configured to cause the control unit to:
process the mixed reception signal, and
serve as:
an acquisition unit configured to acquire the mixed reception signal received by a specific reception antenna that is the reception antenna;
a definition unit configured to define a plurality of decode signals obtained by decoding the acquired mixed reception signal for each code;
an estimation unit configured to estimate a reception signal component corresponding to each transmission signal in the mixed reception signal before decoding, from each decode signal corresponding to the plurality of types of transmission signals; and
a removal unit configured to remove, from the mixed reception signal, the reception signal component corresponding to a transmission signal other than a target transmission signal among the plurality of types of transmission signals.

2. The radar device according to claim 1, wherein
the at least one transmission antenna includes a plurality of transmission antennas, and
the transmission signal generation unit generates, for each transmission antenna, the plurality of types of transmission signals modulated by the plurality of different codes for each antenna set, wherein each antenna set includes at least one transmission antenna.

3. The radar device according to claim 2, wherein
each antenna set includes one transmission antenna that is the at least one transmission antenna.

4. The radar device according to claim 2, wherein
each antenna set includes a plurality of transmission antennas that are the at least one transmission antenna.

5. The radar device according to claim 1, wherein
the transmission signal generation unit generates, for one of the least one transmission antenna, a transmission signal that is a mixture of the plurality of types of transmission signals modulated with the plurality of different codes.

6. The radar device according to claim 1, wherein
the definition unit is configured to convert the plurality of decode signals into a frequency spectrum, and
the estimation unit is configured to extract a peak from the frequency spectrum, and estimate the reception signal component by multiplying a conversion signal defined by an inverse Fourier transform of the peak by at least one of the plurality of different codes.

7. The radar device according to claim 1, wherein
the definition unit is configured to convert the plurality of decode signals into a frequency spectrum, and
the estimation unit is configured to acquire peak information relating to a peak in the frequency spectrum, and
estimate the reception signal component by multiplying a sinusoidal signal according to the peak information by at least one of the plurality of different codes.

8. The radar device according to claim 1, wherein
the definition unit is configured to convert the plurality of decode signals into a frequency spectrum,
the radar device further includes a storage that stores, in a storage medium, peak information of the frequency spectrum corresponding to each code and the reception signal component estimated according to the peak information, and
the storage erases the peak information from the storage medium after estimating the reception signal component.

9. The radar device according to claim 1, wherein
the definition unit is configured to convert the plurality of decode signals into a frequency spectrum,
the radar device further includes a storage that stores, in a storage medium, peak information of the frequency spectrum corresponding to each code and the reception signal component estimated according to the peak information, and
the storage holds the peak information until the removal unit removes the reception signal component from the mixed reception signal.

10. The radar device according to claim 1, wherein
the definition unit is configured to convert the plurality of decode signals into a frequency spectrum, and
the estimation unit is configured to correct influence of a window function in conversion of the plurality of decode signals into the frequency spectrum.

11. The radar device according to claim 1, wherein
the definition unit is configured to
convert the plurality of decode signals to which a window function other than a rectangular window is applied before decoding into a frequency spectrum, and
apply the rectangular window when converting the plurality of decode signals into the frequency spectrum.

12. A radar control method executed by a processor for controlling a radar device including: at least one transmission antenna; a transmission signal generation unit configured to generate a plurality of types of transmission signals modulated by a plurality of different codes to be transmitted from the at least one transmission antenna;
a reception antenna configured to receive a mixed reception signal obtained by mixing each transmission signal reflected by a reflection object, the radar control method comprising:
acquiring the mixed reception signal received by a specific reception antenna that is the reception antenna;
defining a plurality of decode signals obtained by decoding the acquired mixed reception signal for each code;
estimating a reception signal component corresponding to each transmission signal in the mixed reception signal before decoding from each decode signal corresponding to the plurality of types of transmission signals; and
removing, from the mixed reception signal, the reception signal component corresponding to a transmission signal other than a target transmission signal among the plurality of types of transmission signals.

13. A non-transitory computer-readable storage medium storing a radar control program for controlling a radar device including at least one transmission antenna; a transmission signal generation unit configured to generate a plurality of types of transmission signals modulated by a plurality of different codes to be transmitted from the at least one transmission antenna; a reception antenna configured to receive a mixed reception signal obtained by mixing each transmission signal reflected by a reflection object, the radar control program comprising instructions causing a processor to:
acquire the mixed reception signal received by a specific reception antenna that is the reception antenna;
define a plurality of decode signals obtained by decoding the acquired mixed reception signal for each code;
estimate a reception signal component corresponding to each transmission signal in the mixed reception signal before decoding from each decode signal corresponding to the plurality of types of transmission signals; and
remove, from the mixed reception signal, the reception signal component corresponding to a transmission signal other than a target transmission signal among the plurality of types of transmission signals.
